(19) United States
(12) Patent Application Publication
(10) Pub. No.: US 2004/0109321 A1
(43) Pub. Date: Jun. 10, 2004

(54) C-type bulb assembly

(76) Inventor: Chin-Weih Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/310,895

(22) Filed: Dec. 6, 2002

(51) Int. Cl. F21V 17/06

(52) U.S. Cl. 362/363; 362/433; 362/455

(57) ABSTRACT

The present invention relates to a C-type bulb assembly, which includes a bulb holder connecting with a bulb and a connector. A C-type shell is connected with the holder outside the bulb, wherein the opening fringe of the holder is formed with several slots to become several elastic pieces. By use of the elastic pieces, the connecting end of the shell can be firmly engaged with the piece of the holder meanwhile the C-type shell can still be taken off as desired

### BACKGROUND OF THE INVENTION

A conventional C-type bulb assembly includes a bulb holder (1) connecting with a bulb (2) and a connector (3) for receiving the holder (1) therein. A C-type shell (4) is provided outside the bulb (2) that forms a C-type bulb assembly. The conventional C-type shell (4) is directly connected with the holder (1) in force. Since the C-type shell (4) has large volume and weight, the connection must be tight or it will be easily loosed. When the connection between the shell (4) and the holder (1) is secure, it will be trouble to take off the shell (4) from the holder (1) and replace a bulb (2) as being broken.

Accordingly, the primary object of the invention is to provide a C-type bulb assembly, which has elastic pieces on the bulb holder to engage with the C-type shell firmly and conveniently while the shell can also be taken off in ease. Now the features and advantages of the present invention will be described in detail with reference to the accompanying drawings.

### BRIEF DESCRIPTION OF ACCOMPANYING DRAWINGS

FIG. 1 is an exploded perspective view showing a C-type bulb assembly according to the present invention.

FIG. 2 is a perspective view showing the C-type bulb assembly of FIG. 1 being partly assembled.

FIG. 3 is a completely assembled perspective view of FIG. 1.

FIG. 4 is a cross-sectional plan view of FIG. 2.

FIG. 5 is a cross-sectional plan view of FIG. 3.

### DETAILED DESCRIPTION OF PREFERRED EMBODIMENTS

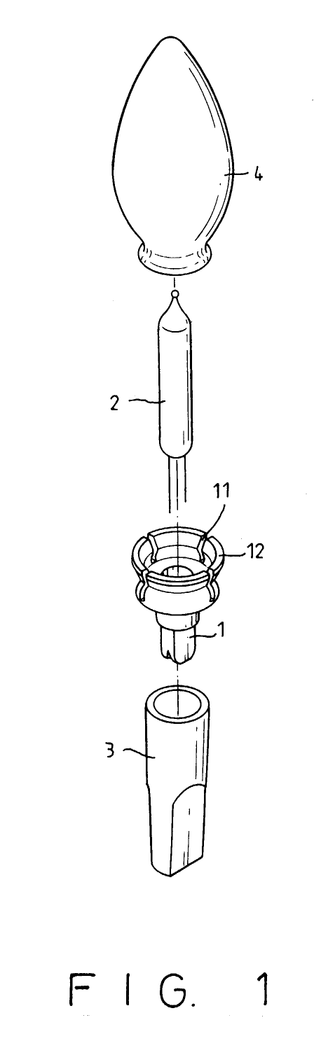

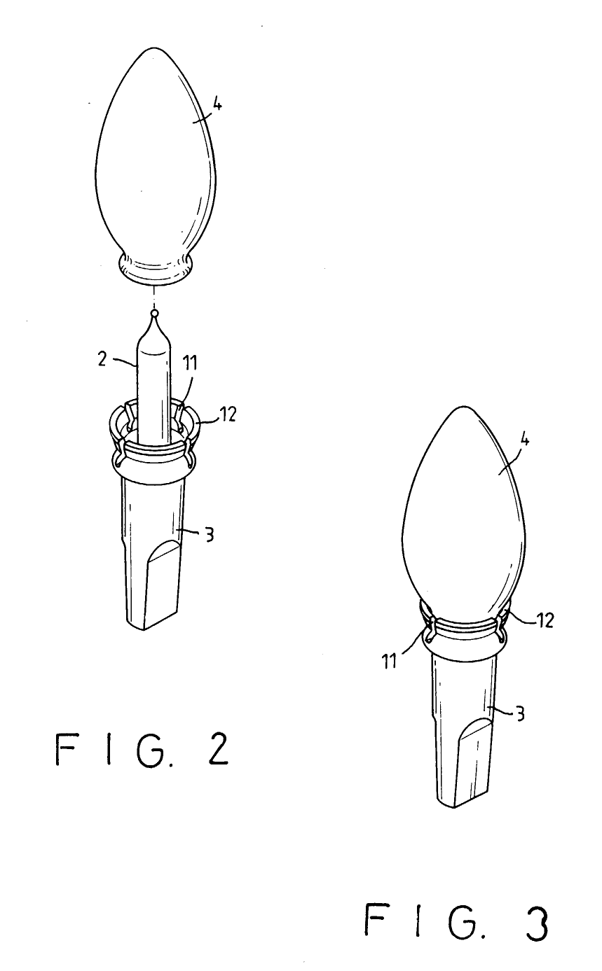

Please refer to FIGS. 1 to 3, the present invention includes a bulb holder (1) connecting with a bulb (2) and a connector (3) for receiving the holder (1). A C-type shell (4) is connected with the holder (1) to form a complete C-type bulb assembly.

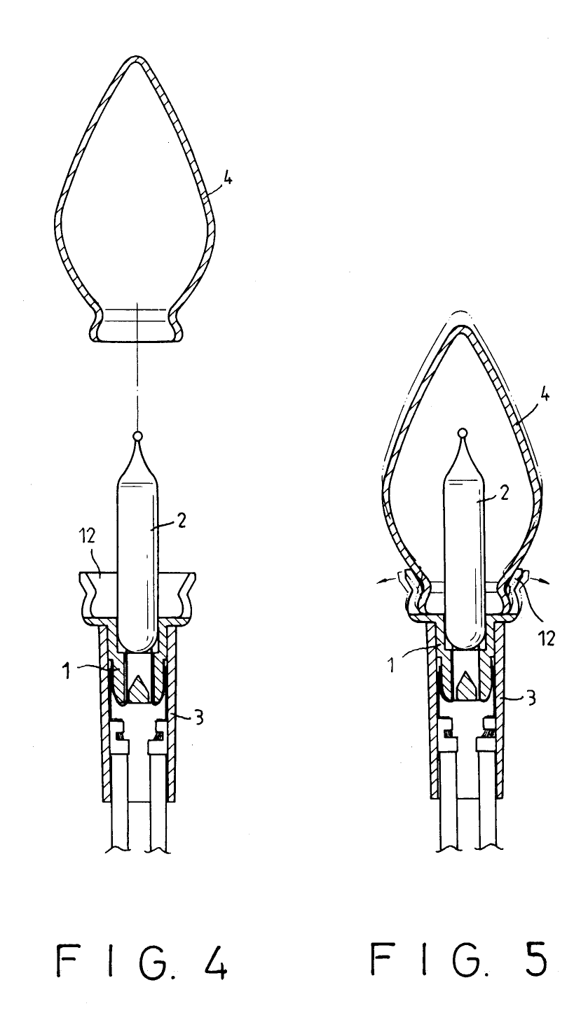

The characteristic of the present invention is that the opening fringe of the holder (1) has a similar shape to the connecting end of the shell (4). The opening fringe of the holder (4) is provided with at least four slots (11) that forms four elastic pieces (12) on the holder (1). Hence, when to assemble the C-type shell (4) with the holder (1), the connecting end can be elastically engaged with the pieces (12) of the holder (1), as shown in FIG. 4 and 5. So the elastic piece (12) provides a secure connection for the C-type bulb assembly. Since the piece (12) is elastic, the C-type shell (4) is capable of being taken off from the holder (1) in order that a broken bulb can be replaced conveniently.

Accordingly, the present invention provides the elastic pieces on the holder that can firmly engage with the C-type shell while the shell can still be taken off if desired. It obviously achieves utility and improvement and should be allowed for patent.

What is claimed is:

1. A C-type bulb assembly including a bulb holder connecting with a bulb and a connector for receiving the holder, a C-type shell being connected with the holder to form a complete C-type bulb assembly;
the characteristic is that opening fringe of the holder having a similar shape to the connecting end of the shell, wherein the opening fringe of the holder being provided with at least four slots that forms four elastic pieces on the holder, and when to assemble the C-type shell with the holder, the connecting end can be elastically engaged with the pieces of the holder while the C-type shell can be taken off as desired.
